(19) United States
(12) Patent Application Publication
(10) Pub. No.: US 2026/0160126 A1
(43) Pub. Date: Jun. 11, 2026

(54) MOTORIZED VERTICAL BLIND ASSEMBLY

(71) Applicant: Hunter Douglas Industries B.V., Rotterdam (NL)

(72) Inventors: Jörg BOHLEN, Rotterdam (NL); Heiko LILIENTHAL, Rotterdam (NL); Kiyoumars FAROKHYAR, Rotterdam (NL)

(21) Appl. No.: 18/707,340

(22) PCT Filed: Oct. 28, 2022
(86) PCT No.: PCT/EP2022/080210

§ 371 Date: May 3, 2024

(30) Foreign Application Priority Data
Apr. 11, 2021 (GB) 2115848.0

(51) Int. Cl. E06B 9/36

(52) U.S. Cl. CPC E06B 9/368; E06B 9/361

(57) ABSTRACT

A motorized vertical venetian blind window covering assembly includes an elongated motor assembly couplable to a rear wall of a headrail so that it extends parallel to the head rail. The elongated motor assembly includes an elongated first housing having a first end, a second end, and an internal space which houses a motor with a drive output extending outside the first end of the housing and couplable to a drive mechanism in the head rail, a battery pack and a motor control board. The elongated motor assembly further includes a supplementary drive shaft having a first end and a second end, with the first end couplable to the drive output of the motor such that the supplementary drive shaft is an elongated extension of the drive output and of the first housing.

### TECHNICAL FIELD

The following relates to a motorized Vertical Venetian blind assembly, in particular to such a blind assembly having a motor assembly coupled to the head rail thereof.

### BACKGROUND

A variety of vertical Venetian blind assemblies are known having a motor assembly coupled to the headrail of the vertical Venetian blind. Known assemblies include those having the motor assembly coupled to the rear of the headrail and extending parallel along the head rail hidden from sight for the user. Such an assembly is disclosed in EP1069276B1.

EP1069276B1 discloses a motorized vertical venetian blind with the motor coupled to the rear wall of the head rail at the left-hand end of the rail. One face end of the motor assembly being parallel to the left face end of the head rail. At the location of the headrail where the motor assembly is coupled to the rear wall there is no space available for a bracket for mounting the blind. Typically, such motorized vertical venetian blind assemblies are mounted to wall or ceiling using two or more mounting brackets coupled to the head rail at a position spaced apart from the end faces of the headrail, i.e. beyond the location of the motor assembly.

However, if the motor assembly is heavy and/or long a bracket is needed adjacent the face end in order to prevent sagging of the end of the rail that carries the motor assembly.

CN208251997U discloses a similar arrangement, albeit with a battery housing included. As can be seen this lengthens the motor assembly. For mounting CN208251997U provides combination bracket which are installed on the rail and the driving mechanism by screws for mounting the driving mechanism and the rail to the wall or ceiling. One of these combination brackets is shown to be attached to the head rail adjacent the face end using. It is not desirable to need special brackets because it causes additional cost as well as a bigger inventory of parts for the manufacturer.

DE8808097U1 proposes to mount the motor assembly to a face end of the head rail. Mounting the motor assembly to an end face of the head rail increases its length with a section where no covering (no slats) can be present. This limits the manner in which the blind can be mounted to wall or ceiling while still being able to completely cover the architectural opening.

DE9406083U1 proposes to mount the motor assembly to a face end of the head rail having a battery compartment at the front and the actual motor at the rear of the head rail. Mounting the motor and the battery compartment in this manner, results in having the battery compartment in plain view for the user which is generally not desirable.

### SUMMARY OF THE INVENTION

As described herein, there is provided a motorized vertical venetian blind assembly as defined in claim 1. The blind assembly including an elongated head rail having a first longitudinal face end, a second longitudinal face end, a top wall and pair of depending front and rear walls extending between the first and second longitudinal face ends and defining an inner headrail space. The inner head rail space is suitable for housing at least covering material carrier and a drive mechanism for moving the covering material. The blind assembly also includes an elongated motor assembly couplable to a rear wall of the headrail so that it extends parallel to the head rail. The elongated motor assembly includes an elongated first housing defining an internal space which houses a motor with a drive output couplable to the drive mechanism in the head rail, a battery pack and a motor control board. The motor assembly further includes a supplementary drive shaft having a first shaft end and a second shaft end, the first shaft end couplable to the drive output of the motor such that the supplementary drive shaft is an elongated extension of the drive output and of the first housing.

By providing the supplementary drive shaft as an extension to the first housing space is created between the rear wall of head rail and the motor assembly parallel to the supplementary drive shaft. This space facilitates mounting of the head rail to mounting brackets at the location of the motor assembly. The space facilitates mounting and dismounting the blind assembly at the location of the motor assembly, even with the mounting brackets having features projecting beyond the width of the head rail. Such a feature could be a dismount tab of a spring bracket. For such brackets dismounting the headrail is done by manipulating the dismount tab which extends to the rear of the head rail (to keep it out of view). With the space between the rear wall of the head rail and the motor assembly this dismount tab can be reached by extending a tool such as e.g. a screwdriver through the space upward i.e. toward the top wall of the headrail and pushing the dismount tab upward.

Thus, a bracket projecting beyond the width of the head rail can be provided adjacent the face end of the motorized end of the blind. Being able to use a mounting bracket at this location prevents the motorized end of the blind from sagging due to the weight of the motor assembly. There is also no need for special combination brackets as proposed in the prior art. Thus, the supplementary drive shaft also allows for using narrow (and thus longer) motors. A narrow motor allows the motorized blind assembly to be mounted closer to the window and thus reducing the spacing between the blind assembly and the window.

The motor assembly may be provided with at least one integrally formed coupling clip for coupling the assembly to the head rail.

The supplementary drive shaft may be provided with a cover. Such a cover protects the shaft from dirt and provides safety for users.

The cover may be in the shape of a second housing and the second housing may be an elongated extension of the first housing, and the second housing may include at least a first area of reduced cross-section such that when coupled to the first housing and to the head rail a first gap between the rear wall of the head rail and the second housing is formed.

A housing is better at protecting from dirt and safer for users. Especially when a tool is extended upwards through the gap to manipulate a dismount tab from a mounting bracket.

If only a simple cover is used instead of a housing the tool may still touch the supplementary drive shaft.

The second housing may include a second area of reduced cross-section. This second area is at the top of the second housing and when coupled to the first housing and the head rail the top of the second housing is lower than the top of the head rail. This creates a space for a wall mounted bracket.

The second housing may be tubular and the first and/or second area of reduced cross-section may be a flattened area.

The first housing may also be tubular.

Using tubular housings allows for ease of assembly. Also, tubular motors generally are smaller in cross-section than other types of motors may be used. This allows for the blind to be mounted closer to the window.

According to a further aspect the drive output is coupled to the supplementary drive shaft by the second housing being coupled to the first housing.

Both the first and second housing being tubular.

The reduced cross-section of the second housing being created a first flattened area parallel to the rear wall of the head rail.

The second housing being provided with a second flattened area parallel to the top wall of the head rail. (for wall bracket).

One of the face ends of the head rail may be provided with a drivable gear that is coupled to the drive mechanism, the second end of the supplementary drive shaft may be provided with a driven gear and a drive belt may be provided to couple the driveable and driven gears.

By providing these features as narrow way of transferring the drive from the motor to the drive mechanism inside the head rail is provided. The driveble and driven gears are narrow in thickness so there is only a small amount of length added to the headrail.

These and other features and advantages of the present disclosure will be readily apparent from the detailed description, the scope of the invention being set out in the appended claims.

### BRIEF DESCRIPTION OF THE DRAWINGS

Implementation of the invention will be more clearly understood from the following description, given by way of example only, with reference to the accompanying drawings, in which:

FIG. 1 is a top view of a motorized vertical venetian blind showing the headrail, motor assembly first housing and supplementary drive shaft;

FIG. 2 is a top view of the motorized vertical venetian blind of FIG. 1 in which the supplementary drive shaft is provided with a cover in the form of a second housing.

FIG. 3. is a perspective view of the motor assembly of FIG. 2

FIG. 4 is a partial view of the blind assembly at its first face end with the supplementary drive shaft and drive gear.

FIG. 5 is an exploded view of the motor assembly of FIG. 2 and FIG. 3.

### DETAILED DESCRIPTION

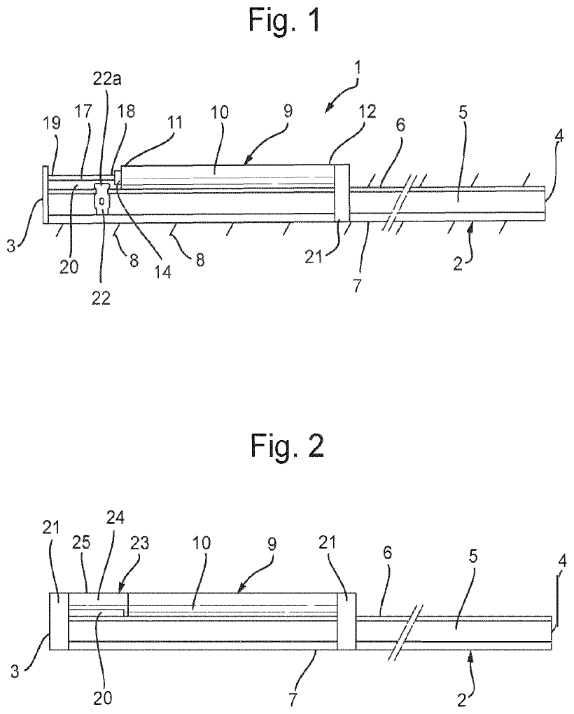

FIG. 1 shows a motorized vertical venetian blind assembly 1 (also referred to as “blind assembly”). The blind assembly includes an elongated head rail 2 having a first longitudinal face end 3, a second longitudinal face end 4, a top wall 5 and a pair of rear and front walls 6, 7 depending from the top wall. The top, rear and front wall creating an inner space for at least a drive mechanism (not visible in the figures) for driving the blind material such as the slats. The blind assembly has a plurality of vertical slats 8, which may be stacked close together adjacent the first longitudinal face end 3 or be traversed along the head rail from the first longitudinal face end 3 to the second longitudinal face end 4 after which the slats are spaced apart along the head rail. FIG. 1 shows the spaced apart situation of the slats 8. The slats may also be tilted between an open position when the light passes between the slats or a closed position in which the slats overlap and no light passes between them. Instead of providing drive means for traversing and tilting the slat, the blind assembly may also be a so-called ‘tilt-only’ blind assembly in which the slats only be driven to tilt and cannot be driven to traverse along the head rail.

As shown in FIG. 1 the blind assembly is provided with an elongated motor assembly 9 coupled to the rear wall 6 of the head rail 5 and extends parallel to the headrail. The rear wall 6 being the wall of the headrail which when the blind assembly is mounted in front of a window is closest to the window pane. Such a motor assembly generally is an optional feature for the user and thus is made couplable to the head rail instead of being presented as integral to the headrail.

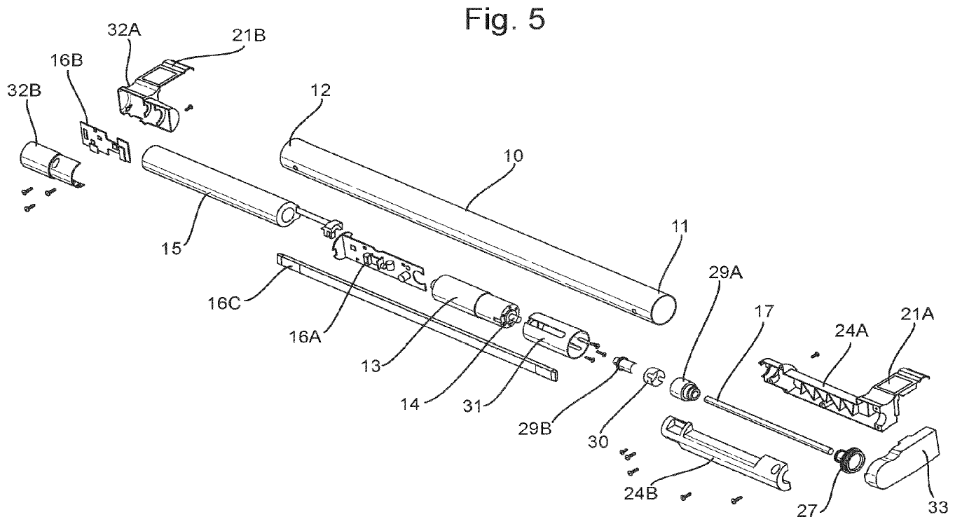

The elongated motor assembly 9 has an elongated first housing 10 having a first end 11 and a second end 12. The housing also has an internal space (not visible in the figures) which houses a motor 13 with a drive output 14, a battery pack 15 and a motor control board 16. These parts are visible in FIG. 5.

The elongated motor assembly 9 further including a supplementary drive shaft 17 having a first end 18 and a second end 19. The first end 18 of the supplementary drive shaft 17 is coupled to the drive output 14 of the motor assembly which extends outside of the first end 11 of the first housing 10. As can be seen in FIG. 1 the supplementary drive shaft 17 is an elongated extension of the drive output 14 and of the first housing 10 of the motor assembly 9. By coupling the motor assembly 9, which includes the supplementary drive shaft 17, to the rear wall 6 of the head rail a space is created between the head rail and the supplementary drive shaft 17. This space is parallel to the supplementary drive shaft and is called a first gap 20.

The motor assembly is coupled to the head rail using at least one coupling clip 21. FIG. 1 shows the use of a single such coupling clip 21 at the second end 12 of the first housing of 10 the motor assembly 9. The coupling clip 21 of FIG. 1 is integrally formed with the motor assembly.

The first gap 20 allows for a mounting the blind to a wall or ceiling by coupling the headrail with its top wall 5 to a mounting bracket 22. The mounting bracket 22 as shown in FIG. 1 is wider than the head rail and has a dismount tab 22A which extends beyond the rear wall 6 of the head rail 2 and into the first gap 20. The dismount tab 22A of the bracket 22 may be reached by extending a tool such as e.g. a screwdriver (not shown) through the first gap 20 upward (i.e. toward the top wall of the headrail) and pushing the dismount tap 23 upward. Pushing the tab upward bracket releases the head rail from the grip of the bracket and the headrail may be dismounted. Such mounting brackets with dismount tabs generally used in the blind field and are also known as so-called clip-in brackets and usually made of spring steel. In order to keep the bracket 22 out of sight the bracket is mounted with its dismount tab extending to the rear of the head rail.

Depending on the length of the head rail two or more such mounting brackets 22 may be used for mounting the blind to the ceiling.

FIG. 2 is a top view of the motorized vertical venetian blind 1 of FIG. 1 in which the supplementary drive shaft 17 is provided with a cover 23 in the form of a second housing 24. The slats 8 have been omitted from FIG. 2.

The second housing 24 is an elongated extension of the first housing 10. The second housing 24 has at least one area 25 of reduced cross section. When the motor assembly 9 with both the first and second housings 10, 24 is coupled to the rear wall 6 of the headrail 2, the first area 25 with reduced cross-section 25 creates the first gap 20 between parallel between the second housing and the rear wall of the head rail.

Even though the second housing takes up more space than the supplementary drive shaft without cover, the first gap 20 is still formed. The dimensions of the second housing and in particular the area of reduced cross-section have been chosen such that the first gap 20 is wide enough to allow tab 22A of the bracket 22 to be reached via the gap for dismounting of the headrail.

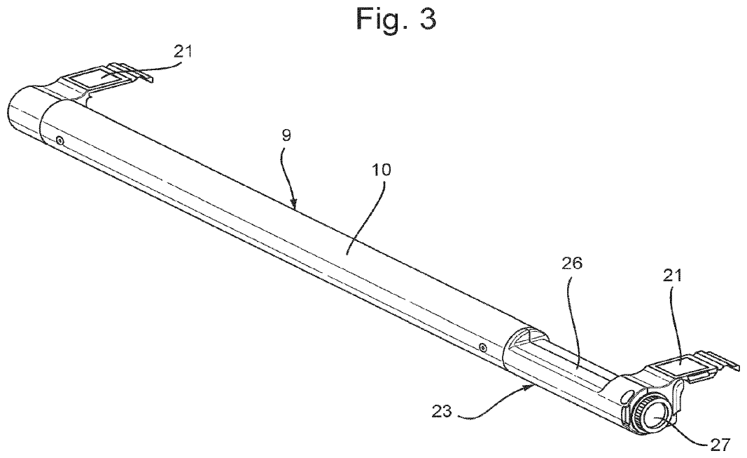

In a further embodiment as shown in a perspective view in FIG. 3 the motor assembly of FIG. 2 may be tubular. Thus FIG. 3 shows a tubular first housing 9 and a tubular second housing 23. The second housing further is provided with a second area of reduced cross-section 26. This second area 26 is at right angles to the first reduced cross-section 25 (not visible in this figure). The second area 26 is at a top plane of the second housing. When the motor assembly is coupled to the rear wall of the head rail, this area is lower than the top of the head rail.

This top area 26 creates a space which is useful when an extendable wall mounting brackets is used to mount the blind. Such wall mounting brackets are L-shaped, having a first wall leg for mounting to a wall and at right angles to the wall leg there is a bracket leg. The bracket leg carries a clip-on bracket of the type shown in FIG. 1. The bracket leg may be provided with a slidable part which is fixed by means of a bolt and nut combination to the bracket leg. The slidable part includes a slot through which the bolt extends. The second area 26 creates room for the end of the bolt and the nut.

In this manner the motor assembly may be used with clip-on ceiling brackets as well as with extendable wall mounting brackets.

The motor assembly of FIG. 3 further shows a pair of coupling clips 21 which are integral to the motor assembly. One of the coupling clips is part of the first housing and is at the second end of the first housing. The other one coupling clips is part of the second housing adjacent the second end 19 of the supplementary drive shaft 17.

The supplementary drive shaft 17 projects a bit beyond the end of the second housing where it is provide with a drive gear 27.

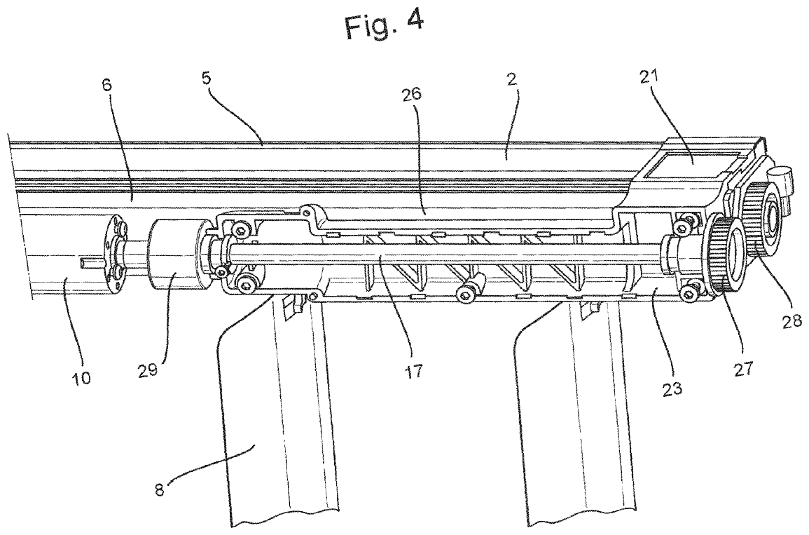

FIG. 4 is a partial view of the blind assembly 1 at its first face end 3 with the supplementary drive shaft 17 and drive gear 27. Adjacent the drive gear 27 there is a driven gear 28. The drive gear 27 and driven gear 28 are to be connected using a toothed drive belt (not shown in this figure).

In use when the motor is driven the drive is transferred by the drive output to the supplementary drive shaft and to the drive gear 27. By means of the drive belt the driven gear 28 is driven to rotate.

The driven gear is mounted to a blind drive mechanism which is housed at the first longitudinal face end 3 inside the head rail of the blind assembly. This blind drive mechanism may be a so-called mono-commando drive of the type describe in EP1069276 which includes a rotatable tilt drive for tilting the slats; a rotatable retract drive for retracting and deploying slats (i.e. traversing) and a transmission for rotating the tilt drive and the retract drive by means of a single rotatable source. The transmission of the mono-commando drive mechanism of EP1069276 includes a clutch for rotating the tilt drive, the clutch incorporating a first lost motion mechanism whereby after a predetermined number of rotations in the same direction, transmission by the clutch to the tilt drive is disengaged and the retract drive is rotated by the transmission by means of a second lost motion mechanism such that the retract drive is only rotated after a predetermined number rotations of the transmission in the same direction.

In this way, both the tilt and retract operations of a blind may be controlled from a single rotatable source, such as the motor assembly 9 of the current vertical venetian blind assembly 1.

FIG. 4 further illustrates a coupling 29 between the drive output 14 of the motor assembly and the supplementary drive shaft 17. This shown in more detail in FIG. 5.

FIG. 5 is an exploded view of the motor assembly of FIG. 2 and FIG. 3.

FIG. 5 shows the first housing 10 of the motor assembly 9 in which are housed the motor 13 with drive output 14, the battery pack 15 and the motor control board 16. In the example of FIG. 5 the motor control board 16 is divided into two sub-boards 16A and 16B which are connected by cable 16C. The first sub-board 16A is dedicated to the motor control of the motor output 14. The second sub-board 16B houses an interface for the control boards 16A, 16B including a LED light, a programming/reset button as well as a USB-c port. The interface provides possible outside control as well as charging facility for the battery pack. A supplementary housing 32 for the second sub-board may be provided at the second end 12 of the first housing 11 for ease of assembly. The supplementary housing may be a two-part housing having a first and second part 32A, 32B.

The second housing 24 may be a two-part housing having housing parts 24A and 24B. The supplementary drive shaft 17 is housed in the second housing 24. The second housing may be connected to the first housing at the first end 11 of the first housing.

The coupling sleeve 31 is shown which is coupled to the end of motor 13 having the drive output 14. This may be done by a flange that is screwed to the face end of the motor or other suitable means. The coupling sleeve 31 houses the coupling 29 which includes a first coupling part 29A which is fitted to the supplementary drive shaft 17 and a second coupling part 29A which is fitted to the drive output 14 of the motor 13. The first coupling part 29 is a hollow tubular member into which the second coupling part 29B can be received. A noise dampener 30 may be provided co-axially between the first and second coupling parts 29A, 29B.

The coupling clips 21A and 21B for coupling the motor assembly to the head rail 2 may be integrally formed with the second housing 24 and the supplementary housing 32 respectively. In case no supplementary housing 32 is provided one of the coupling clips may be provided on the first housing near the second end 12.

End cap 33 is provided to cover the first face end 3 of the head rail as well as the adjacent end of the second housing. The end cap covers the drive gear 27 and the driven gear 28, and the drive belt between the two gears (not shown in the drawing Figure).

1. A motorized vertical venetian blind window covering assembly, comprising:
an elongated head rail comprising a first longitudinal face end, a second longitudinal face end, a top wall and pair of depending front and rear walls extending between the first and second longitudinal face ends and defining an inner headrail space for housing at least one covering material carrier and a drive mechanism for moving the covering material;
an elongated motor assembly couplable to the rear wall of the headrail so that it extends parallel to the head rail,
the elongated motor assembly comprising an elongated first housing comprising a first housing end and a second housing end and defining an internal space between the first housing end and the second housing end, a motor with a drive output extending outside the first housing end of and couplable to the drive mechanism in the head rail, a battery pack and a motor control board disposed within the internal space of the first housing,
the elongated motor assembly further comprising a supplementary drive shaft having a first shaft end and a second shaft end, the first shaft end couplable to the drive output of the motor such that the supplementary drive shaft is an elongated extension of the drive output and of the first housing.

2. The motorized vertical venetian blind assembly of claim 1, wherein the motor assembly comprises at least integrally formed one coupling clip for coupling the motor assembly to the head rail.

3. The motorized vertical blind assembly of claim 1, wherein the supplementary drive shaft is provided with a cover.

4. The motorized vertical blind assembly of claim 3, wherein the cover is in the shape of a second housing and the second housing being an elongated extension of the first housing, and wherein the second housing comprises at least a first area of reduced cross-section such that when coupled to the first housing and to the head rail a first gap between the rear wall of the head rail and the second housing is formed.

5. The motorized vertical blind assembly of claim 4, wherein the second housing comprises a second area of reduced cross-section such that when coupled to the first housing and the head rail the top of the second housing is lower than the top of the head rail.

6. The motorized vertical blind assembly of claim 4, wherein the second housing is tubular and the first and/or second area of reduced cross-section may be a flattened area.

7. The motorized vertical venetian blind assembly of claim 1, wherein the first housing is tubular.

8. The motorized vertical blind assembly of claim 1, wherein one of the face ends of the head rail is provided with a drivable gear that is coupled to the drive shaft, the second end of the supplementary drive shaft is provided with a driven gear and a drive belt couples the gears.

9. The motorized vertical blind assembly of claim 1, wherein the supplementary drive shaft is coupled to the drive output of the motor by means of a coupling.

10. The motorized vertical blind assembly of claim 10, wherein the coupling is provided with a vibration absorber.
